(19) United States
(12) Patent Application Publication
(10) Pub. No.: US 2011/0232207 A1
(43) Pub. Date: Sep. 29, 2011

(54) Bridge

(76) Inventor: Andrew Dustin Duke, Charlottesville, VA (US)

(21) Appl. No.: 12/661,775

(22) Filed: Mar. 24, 2010

(51) Int. Cl. B66F 3/04

(52) U.S. Cl. 52/126.6

(57) ABSTRACT

A tool designed using a support beam that attaches to the block foundation wall with brackets. A plurality of support screws can be adjusted laterally as needed to line up with the floor joists. Once the support screws are properly placed, they can be manually turned lifting the flooring system as warranted. This invention provides an alternative to disruptive repairs when rot is discovered. The design spans the affected area creating a bridge of support lifting the weight off the rotted area allowing repairs or replacement. The brackets, length of bridge and individual lifting mechanisms operate to level out the flooring in the living area of a home.

### BACKGROUND OF INVENTION

My house was for sale. During a preliminary inspection, I found a rotted seal plate causing my floor to noticeably sag. This would have been extremely expensive repair to remove the wall framing sitting on top the seal plate, to remove the floor joists, underlayment and floor covering. I therefore had to figure out a way to raise the floor joist not only to level the floor but also to mitigate the rot and deterioration which I could access in the crawlspace. I with my job I see this type of unfortunate situation due to repeated seepage through an exterior wall. In my case, the sliding glass door was leaking where a screw was missing.

A house jack will obviously level out the floor, but you can't leave a house jack under the home and still pass an inspection. Nothing can touch the ground other than the foundation, so you can't just prop your flooring system up with wood either because of termites.

Many homes are constructed like mine, especially ones in southern states with crawlspaces. My solution, which would both lift the flooring system using the foundation already in place so I could mitigate the rot, level the floor and also be left in place permanently if warranted, was my invention. My prototype worked great. It was placed between the two foundation columns, using brackets which just set right on top.

My invention then gently raised the flooring joists closest to the rot, taking the pressure off that damaged area and dispersing the weight onto my invention rather than along the rotted seal plate. I then cut and scraped out the rot, injecting filler and hardener to the deteriorated seal plate. My invention effectively became the seal plate for those joists and leveled out my floor. Because the seal plate was compromised where the end butted into the adjoining seal plate, and therefore could not be completely stabilized, I simply left my prototype in place.

Often in construction, if there is a rotted floor joist, they can be “sistered” which means they attached wood to either side and glue or bolt it. This method can actually make the joist stronger. But if anything attached on the foundation or block wall (top plate or seal plate) rots, there is no way to “sister” it. One must remove all components attached to the damaged area to remediate. Now there is way without having to tear everything apart. And since it does not touch the ground, it can be a permenant fix.

### BRIEF DESCRIPTION OF DRAWINGS

FIG. 1. is a front perspective looking directly at the side.

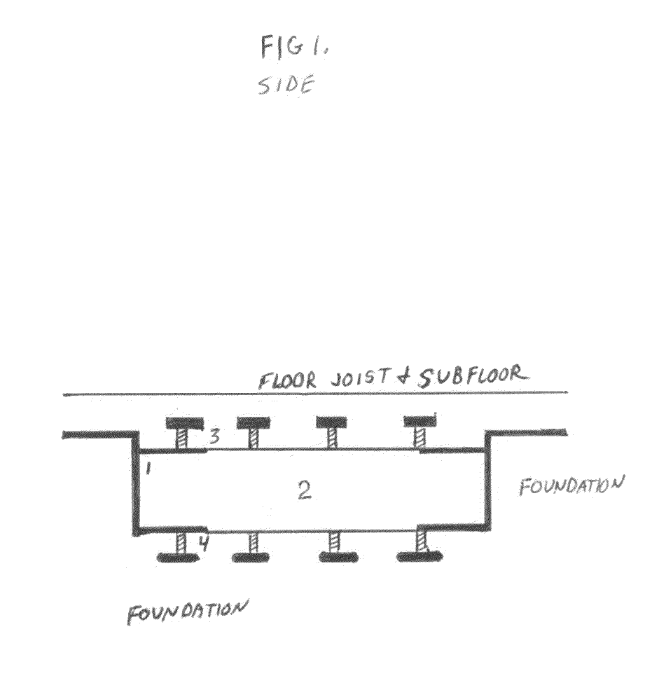

FIG. 2. is a perspective from the top.

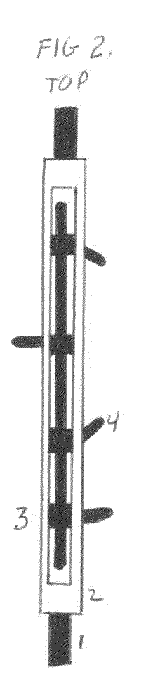

FIG. 3. is a perspective of the parts of the whole.

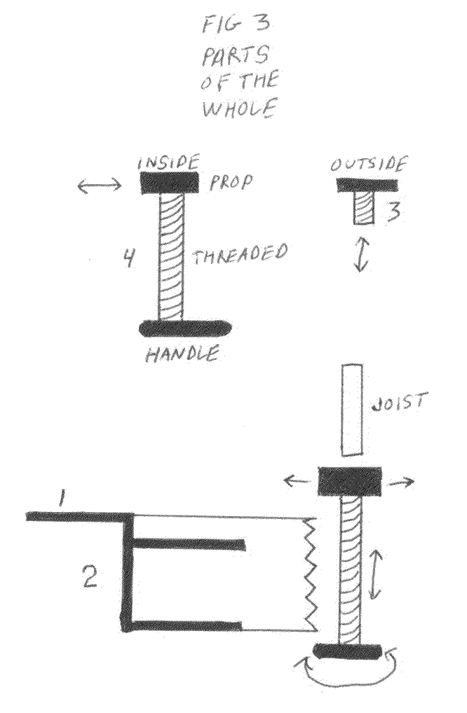

In regards to the FIGURES, each reference numerical is corresponds to each FIGURE. Numerical 1 identifies the bracket which directly contacts or connects to or on the building or building foundation. Numerical 2 identifies the support beam that spans the width of where the joists are to be supported. Numerical 3 identifies the sliding female side to compensate for variances in construction. Numerical 4 identifies the male side that is turned to lift the joist(s); it is threaded through Numerical 3. The top part physically pushes on the joist as the handle is turned.

1. A tool designed with, but not limited to or in conjunction with, the intention of lifting, adjusting or supporting a flooring joist system comprising of but not limited to,
a. a plurity of sizes manufactured with sturdy materials, and;
b. this material described in (a) will be an acceptable functional length, and;
c. at each end of this length described in (b) there will be support brackets that can be comprised of a plurity of designs intended to placed onto, connected to, sit on, attach or rest on the foundation, and;
d. this point of weight transfer described in (c) will be length-wise mechanically adjustable to account for variances in construction, and;
e. once this length (a) with adjustable weight transference points (d) is in place there will be singular and multiple number of threaded bolts with a flat surface opposite end, that;
f. said bolts described in (e) will extend through the length described in (a), and;
g. said bolts described in (e) will have a handle or a plurity of methods to turn clockwise of counter clock wise as warranted to, and;
h. this bolt as described in (f) will fit through a female end that slides back and forth along the upper length of (a) to line up with the joists, and;
i. which then with (a) spanning between the joists, with (e) lined up to its corresponding joist, turning (e) through (g) with make contact with the joist as warranted.
